(19) United States
(12) Patent Application Publication
(10) Pub. No.: US 2009/0127018 A1
(43) Pub. Date: May 21, 2009

(54) COMPONENT COMBINATION FOR A HYDROSTATICALLY DRIVEN VEHICLE

(75) Inventor: Matthew Chisholm, Minneapolis, MN (US)

Correspondence Address: LEYDIG, VOIT & MAYER, LTD, TWO PRUDENTIAL PLAZA SUITE 4900, 180 N. STETSON AVE, CHICAGO, IL, 60601, US

(73) Assignee: CATERPILLAR PAVING PRODUCTS INC., Minneapolis, MN (US)

(21) Appl. No.: 11/943,914

(22) Filed: Nov. 21, 2007

(51) Int. Cl. B60K 17/356

(52) U.S. Cl. 180/307

(57) ABSTRACT

A hydrostatically driven vehicle includes an engine operating at a first speed and operably connected to a variable displacement pump in fluid communication with a hydraulic circuit. The pump includes a rotating swashplate being adapted to operate at selective angles, which dictate pump displacement ranging from zero to a maximum displacement. The pump is capable of providing a pump flow rate at the first speed when the pump swashplate is set to the maximum displacement, wherein the pump flow rate is greater than the maximum flow rate that may be received by the hydraulic circuit.

### TECHNICAL FIELD

This patent disclosure relates generally to hydrostatically driven vehicles and, more particularly, to a combination of components sized to provide operational efficiency.

### BACKGROUND

Hydrostatically driven vehicles typically include a hydraulic pump driven by an engine or motor. The hydraulic pump propels a flow of fluid to one or more actuators, typically hydraulic motors, connected to wheels or other driving features of the vehicle. The flow of fluid from the pump passes through each actuator, causing the vehicle to move along at a travel speed. An operator adjusting a control input, for example, a lever, pedal, or any other appropriate device controls motion of the vehicle. When the operator displaces the control input, a signal is generated by a displacement sensor integrated with the control input or, alternatively, by displacement of a mechanical linkage. The signal is conveyed to a controller associated with the vehicle where it is interpreted and an appropriate command is issued to an actuator associated with the hydraulic pump, the actuator being arranged to move a control aim of the pump operating to change the displacement of the pump. Alternatively, the control input may be mechanically connected to the pump, for example, by cable, which causes the control arm of the pump to move in response to displacement of the control input.

Displacement of the control arm of the pump causes a change in the pump's displacement by changing the angle of operation of a swashplate within the pump and, accordingly, a change in the pressure and flow rate of fluid propelled through the pump. Modulation of the flow rate of fluid also modulates the rate of rotation of hydraulic motors driving the wheels of the vehicle and, therefore, the travel speed of the vehicle. Additional systems may be available for control of the travel speed of the vehicle, for example, braking systems or transmissions may be used to decelerate the vehicle when the operator so desires.

Even though these types of control are generally effective in controlling the vehicle, such hydrostatically driven vehicles generally do not operate efficiently with regard to fuel consumption most of the time. The engine for a typical vehicle, for example, a soil compactor, is arranged for steady state operation at or about 2300 revolutions per minute (RPM). When the vehicle is operating at full power, the pump is set to its highest setting and inefficiencies of the pump cause an increase in fuel consumption. Accordingly, it is desirable to provide an arrangement that overcomes or minimizes one or more of these shortcomings.

### SUMMARY

A hydrostatically driven vehicle includes an engine operating at a first speed and operably connected to a variable displacement pump. The pump includes a rotating swashplate being adapted to operate at selective angles, which dictate pump displacement. Pump displacement ranges from zero to a maximum displacement. A hydraulic circuit is adapted to receive a flow of fluid from the pump, the flow of fluid circulating at a flow rate through the hydraulic circuit. The hydraulic circuit is capable of operating at or below a maximum hydraulic circuit flow rate. The pump is capable of pumping the maximum hydraulic circuit flow rate of fluid into the hydraulic circuit while the engine operates at the first speed and while the swashplate is disposed at an operating angle corresponding to an operating displacement that is less than the maximum displacement.

### BRIEF DESCRIPTION OF THE DRAWINGS

FIG. 1 is an outline view of a soil compactor as one example for a hydrostatically driven vehicle in accordance with the disclosure.

FIG. 2 is a schematic diagram of a hydraulic system in accordance with the disclosure.

FIG. 3 is a schematic cross section of a simplified variable displacement pump.

FIG. 4 is a graph qualitatively plotting flow rate versus outlet pressure for a variable displacement pump.

FIG. 5 is a comparison of two graphs, each corresponding to a variable displacement pump, in accordance with the disclosure.

### DETAILED DESCRIPTION

This disclosure relates to hydrostatically operated machines. The examples presented for illustration relate to a hydrostatically driven vehicle and, more specifically, to a combination of components of the vehicle that yield a reduced engine operating speed for optimization of most operating conditions. The present disclosure is applicable to any type of machine having a hydraulic system associated therewith. In the exemplary vehicle presented, the engine can operate at a lower engine speed and torque output when the demand of the vehicle is less than a maximum demand and the flow of fluid is at a maximum flow. According to the disclosure, this reduction in engine speed is accomplished by use of a pump having a larger maximum displacement than pumps used in the past, even though the pump may be so sized that it will never operate at a maximum displacement setting because the hydraulic system of the vehicle is incapable of accepting such a flow. In this manner, the operation of the vehicle and, accordingly, any other hydraulically operated machine, may be optimized.

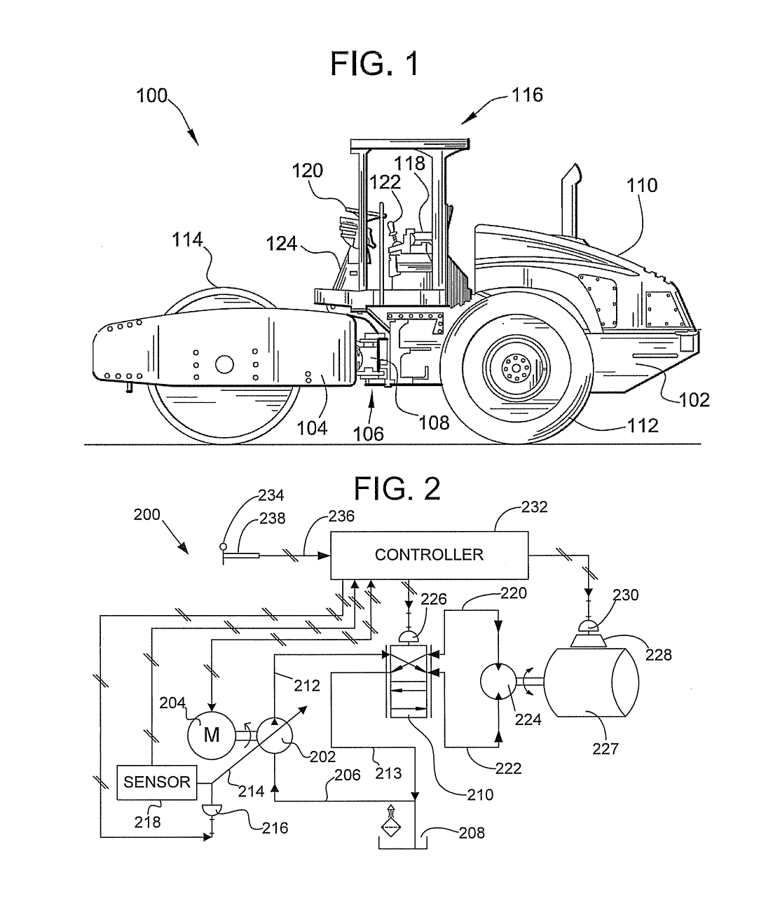

FIG. 1 shows an outline view of a vehicle 100 as one example of a hydrostatically driven vehicle. Although a soil compactor is illustrated in FIG. 1, the term “vehicle” may refer to any hydrostatic machine that performs some type of operation associated with an industry such as mining, paving, construction, fanning, transportation, or any other industry known in the art. For example, the vehicle 100 may be an earth-moving machine, such as a wheel or track loader, excavator, dump truck, backhoe, motor-grader, material handler or the like.

The vehicle 100 includes an engine frame portion 102 and a non-engine frame portion 104. An articulated joint 106 that includes a hinge 108, which allows the vehicle 100 to steer during operation, connects the two portions of the frame 102 and 104. The engine portion 102 of the frame includes an engine 110 and a set of wheels 112 (only one wheel visible). The engine 110 can be an internal combustion engine, for example, a compression ignition engine, but, in general, the engine 110 can be any prime mover that provides power to various systems of the vehicle by consuming fuel.

In the exemplary vehicle 100 presented herein, the non-engine frame 104 accommodates a drum 114 that rotates about a centerline thereof while the vehicle 100 is in motion. An operator occupying a cab 116 typically operates the vehicle 100. The cab 116 may include a seat 118, a steering mechanism 120, a speed-throttle or control lever 122, and a console 124. An operator occupying the cab 116 can control the various functions and motion of the vehicle 100, for example, by using the steering mechanism 120 to set a direction of travel for the vehicle 100 or using the control lever 122 to set the travel speed of the vehicle. As can be appreciated, the representations of the various control mechanisms presented herein are generic and are meant to encompass all possible mechanisms or devices used to convey an operator's commands to a vehicle.

A simplified circuit diagram for a hydraulic system 200 including electrical controls is shown in FIG. 2. The system 200, shown simplified for purposes of illustration, includes a portion of the drive circuit for driving the drum 114 of the vehicle 100. As can be appreciated, hydraulic components and connections to drive the wheels 112, or vibrators (not shown) within the drum 114 are not shown for the sake of simplicity. Similar hydraulic components and connections may be provided in alternate hydrostatically driven vehicles to perform operations such as, by way of example only, lifting and/or tilting of attached implements.

The hydraulic circuit 200 includes a variable displacement pump 202 connected to a prime mover, in this case, the engine 204 of the vehicle. The pump 202 has an inlet conduit 206 connected to a vented reservoir or drain 208. When the engine 204 (such as engine 110) is operating, the pump 202 draws a flow of fluid from the reservoir 208 that it pressurizes before sending it to a four-port two-way (4-2) valve 210 via a supply line or conduit 212. A drain port of the valve 210 is connected via a drain passage 213, which drains to the reservoir 208. A control lever 214 is connected to a swashplate (not shown) internal to the pump 202 and arranged to change the angle of the swashplate in response to motion of control lever 214. Motion of the control lever 214 is accomplished by an actuator 216 connected to the control lever 214. The displacement or angle of the control lever 214, which is equivalent to the angle of the swashplate of the pump 202, may be sensed or measured with a sensor 218. The sensor 218 may be, for example, an analog or digital sensor measuring the angle (or, equivalently, the displacement) of the control lever 214 and, hence, the position of the swashplate within the pump 202.

In use, the pump 202 functions to propel a flow of fluid through the supply line 212 when the engine 204 operates. Depending on the position of the 4-2 valve 210, the flow of fluid from the supply line 212 is routed into one of two conduits, a first conduit 220 and a second conduit 222, which are respectively connected to either side of a hydraulic motor 224. The position of the 4-2 valve 210 is controlled by a valve actuator 226 disposed to reciprocally move the 4-2 valve 210 between two positions causing the motor 224 to move in the desired direction. In an alternate embodiment, the 4-2 valve may be replaced by a bidirectional variable displacement pump (not shown) capable of routing fluid to the motor 224 in both directions.

The motor 224 is connected to a wheel or drum 227 of the vehicle (such as wheel 112 or drum 114) and arranged to rotate the wheel or drum 227 when the vehicle is travelling. A brake 228, shown schematically, is arranged to arrest or stall motion of the drum 227 when actuated by an actuator 230. The brake actuator 230 shown in this embodiment is electronic and actuates the brake 228 causing function to arrest motion of the drum 227, but other configurations may be used. For example, a pin may be inserted into an opening of a rotating disk connected to the drum 227 such that motion of the disk and drum 227 with respect to the pin is stalled, and so forth. Further, the brake 228 is shown external to the drum 227 for illustration, but more conventional designs such as those having the brake 228 protected within the drum 227 may be utilized.

An electronic controller 232 is connected to the vehicle and arranged to receive information from various sensors on the vehicle, process that information, and issue commands to various actuators within the system during operation. Connections pertinent to the present description are shown but, as can be appreciated, a great number of other connections may be present relative to the controller 232. In this embodiment, the controller 232 is connected to a control input 234 (such as control lever 122) via a control signal line 236. The control input 234, shown schematically, may be, for example, a lever moveable by the operator of the vehicle used to set a desired speed setting for the vehicle. The position of the control input 234 may be translated to a command signal through a sensor 238 associated with the control input 234. The control signal relayed to the controller 232 may be used in a calculation, along with other parameters, for example, the speed of the engine 204, the temperature of fluid within the reservoir 208, and so forth, to yield a desired angle for the swashplate that causes the vehicle to move at the desired speed.

When the operator commands motion of the vehicle by displacing the control input 234, a command signal is relayed to the controller 232 via the command input line 236. This signal, as is described in further detail below, causes the pump actuator 216 to move the control lever 214 by an appropriate extent to achieve a desired angle. The desired angle of the control lever 214, which translates into a desired setting for the swashplate of the pump 202, causes an appropriate flow of motive fluid through the hydraulic motor 224, which results in rotation of the drum 227 achieving the desired travel speed of the vehicle.

The various fluid conduits and actuators, for example, the hydraulic motor 224, belonging to the hydraulic system 200 are sized relatively to a maximum flow rate of fluid through the system 200. For example, a calculation for the maximum flow of the system 200 by a designer may account for various parameters, such as, the weight of the vehicle, the maximum travel speed, any grades the vehicle should be capable of traversing during operation, and so forth.

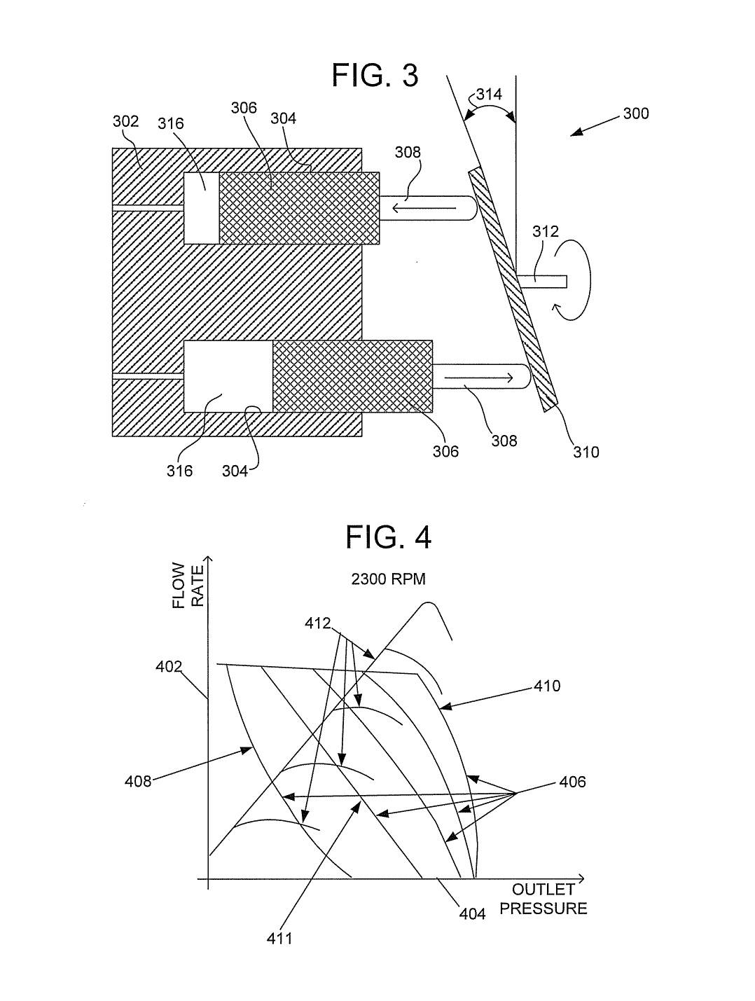

A cross section of a typical arrangement for a variable displacement pump 300 (such as pump 202) is shown in FIG. 3. The variable displacement pump 300 includes a housing 302 forming a plurality of cylindrical bores 304, which are radially arranged parallel to each other within the housing 302. Each bore 304 sealably and reciprocally accepts a plunger 306. Each plunger 306, shown simplified, forms an actuation linkage 308 extending from the plunger 306 and contacting an angled rotating plate or swashplate 310. The swashplate 310 is connected to a rotating shaft 312 and is capable of rotating at an angle 314 with respect to the rotating shaft 312. The angle 314 can be adjusted such that the stroke of each plunger 306 can be altered, thus altering the displacement of the variable displacement pump 300. In a typical arrangement, the shaft 312 rotates under action of a rotating machine, for example, the engine or transmission of a vehicle. Motion of the plungers 306 caused by rotation of the swashplate 310 acts to compress a fluid within a plurality of compression volumes 316 defined between each respective bore 304 and plunger 306. The volume of each compression volume depends on the angle 314 of the swashplate 310.

A qualitative efficiency chart for an exemplary variable displacement pump is shown in FIG. 4. The chart of FIG. 4 is a graphical illustration of parameters plotted against a vertical axis 402, representing a rate of flow for fluid being compressed in a variable displacement pump, and a horizontal axis 404, representing an outlet pressure of the pump. The graph illustrates the relationship between outlet flow versus pressure of the pump as well as the corresponding pumping efficiencies of the pump for various angles or settings of the swashplate, tested under a steady state rate of rotation of an input shaft of the pump, for example, 2300 RPM.

A series of flow curves 406 illustrate the negative correlation between flow rate of the pump and the outlet pressure. The curvature of each flow curve 406 can change depending on the angle setting of the pump. For example, a flow curve 408 corresponding to a low angle setting of the pump has a concave curvature, indicating that flow rates decrease faster as pressure increases from a low pressure condition than they decrease at higher pressure conditions. In contrast, a flow curve 410 corresponding to a high or steep angle setting of the pump has a convex curvature, indicating that the flow rate may decrease faster as pressure increases from a higher pressure condition than it does at a lower pressure. The shape of each flow curve 406 corresponding to an angle setting of the pump is indicative of the efficiency of the pump, with higher efficiencies exhibited for angles corresponding to flow curves 406 having concave shapes. One can surmise that a flow curve 411 corresponding to an intermediate angle will have a generally straight shape at the transition between the concave and convex shaped flow curves 406.

The efficiency of the pump, which can be determined as a ratio between the hydraulic power at the pump outlet and mechanical power at the driving shaft at nominal pressure, angular velocity, and fluid viscosity, is represented on the graph by a plurality of efficiency curves 412, each corresponding to a respective angle setting of the pump. Each efficiency curve 412 has an inflection point indicative of optimum pump performance for each angle setting. It can be appreciated that the relative drop in efficiency when, for example, the pressure deviates from the optimum performance, will increase as the angle settings of the pump increase. It can also be appreciated that low or declining efficiencies of the pump during operation cause a waste of energy and an increase in fuel consumption of the vehicle.

For this and other reasons, issues of increased fuel consumption may advantageously be avoided by incorporation of a larger pump into a vehicle that would have been typically incorporated a smaller pump. By increasing the size of the pump, even to the extent that the pump may never be used at its maximum angle setting, one can advantageously operate the larger pump at a higher efficiency and at a lower shaft speed, thus reducing the fuel consumption of the vehicle while still operating at a high efficiency.

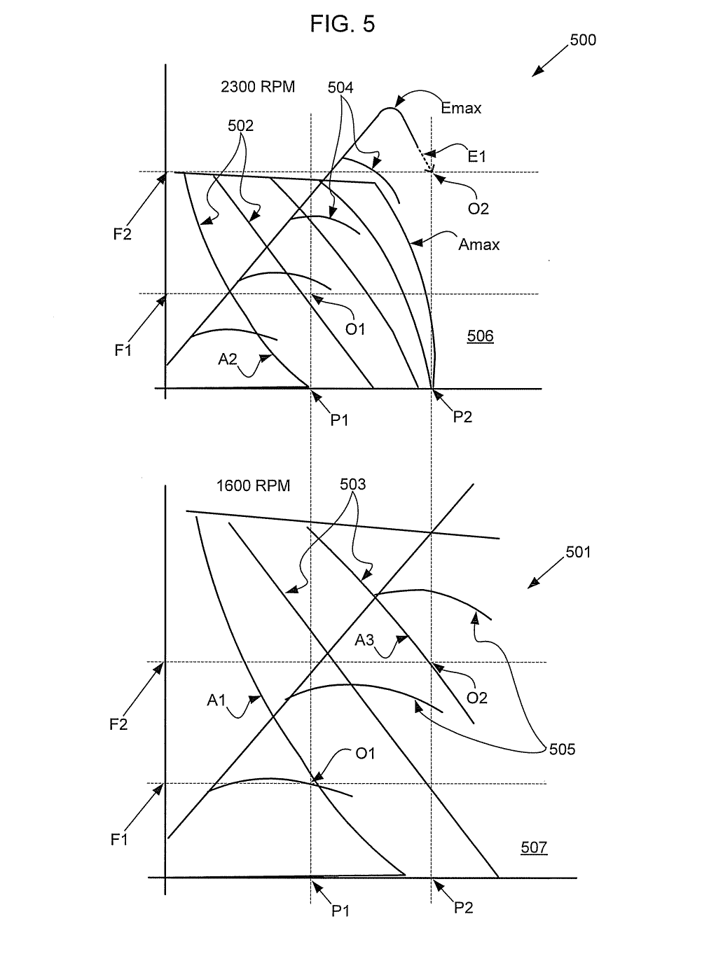

Two qualitative charts indicative of the flow and pressure characteristics of two exemplary pumps are shown for comparison in FIG. 5. The first graph 500 includes flow curves 502 and efficiency curves 504 plotted for data indicative of performance of a first pump 506, a smaller frame pump, while the second graph 501, shown below the first graph 500, includes flow curves 503 and efficiency curves 505 plotted for data generated by a second pump 507, a larger frame pump. The first pump 506 may operate at a steady shaft speed of 2300 RPM, and the second pump 507 may operate at a steady shaft speed of 1600 RPM. The data shown in the first and second graphs 500 and 501 is qualitative and does not represent actual data. Two operating points have been selected for illustration of the operating conditions of each pump under the assumption that they are each used in the same or similar hydraulic systems.

In both charts, a first operating point, O1, corresponds to a pressure, P1, at the outlet of each pump and to a flow rate, F1. Similarly, a second operating point, O2, corresponds to a pressure, P2, at the outlet of each pump and to a flow rate, F2. Dashed lines are used to identify each operating point on both graphs 500 and 501.

Regarding the first pump 506, the operating point O1 can be attained by setting the first pump 506 to a second angle setting, A2. The operating point O2, however, can only be approached, but not attained, by setting the pump at a maximum angle setting, Amax, representing a maximum displacement setting for the pump 506. Operation of the first pump 506 at the maximum angle setting Amax occurs at a very low efficiency, E1. Based on the description above, the combination of the high angle setting Amax, along with operation at the high pressure P2 yields the very low pump efficiency E1 because the first pump 506 is operating at a high angle setting and a high pressure. This condition can be readily seen in the first graph 500 where the low efficiency E1 lies beyond the maximum efficiency Emax for the corresponding angle setting Amax.

Regarding the second pump 507, the operating point O1 can be attained by setting the second pump 507 to a first angle setting, A1, which is relatively less than the second angle setting A2 used on the first pump 506. In contrast with the first pump 506, the second pump 507 can easily attain the second operating point O2 by setting the second pump 507 at a third angle setting, A3, which, for this pump, is also advantageously less than the maximum setting. Operation of the second pump 507 at either the first or second angle settings A1 and A3 can occur at relatively high efficiencies and at a lower shaft speed. If the second operating point O2 is assumed to be representative of the maximum flow rate that a hydraulic system can accept, it can be appreciated that the second pump 507 is capable of pumping the maximum flow rate of fluid into the hydraulic circuit, while operating at 1600 RPM, and while the swashplate is disposed at an operating angle corresponding to an operating displacement that is less than the maximum displacement. In comparing the displacement of the second pump 507 with that of the first pump 506, while both pumps are operating at the operating point O2 at their respective speeds, it can further be appreciated that the displacement of the second pump 507 at the second operating point O2 is at least less than 70% of the maximum displacement.

### INDUSTRIAL APPLICABILITY

The present disclosure is applicable to hydrostatically driven vehicles having an engine or motor driving a variable displacement pump. Typical vehicles use a maximum displacement condition for the pump to size the pump such that the maximum flow rate can be pushed into the hydraulic system of the vehicle when the engine operates at its maximum useable RPM. As described above, this mode of matching a specific pump size to an engine can often lead to operation of the vehicle that is both wasteful of fuel, due to the engine's operation at high speeds, as well as detrimental to the efficiency of the system. The present disclosure, in one aspect, describes using a larger pump paired with the engine that, even if the full displacement of the pump may never be used, allows the system to operate at a high efficiency state. Moreover, the engine operates at a lower RPM during most operating conditions. The advantages of this configuration can be readily appreciated as fuel economy and noise are reduced during operation, and the efficiency of the system is increased.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

I claim:

1. A hydrostatically driven vehicle comprising:
all engine operating at a rotational speed during operation of the vehicle;
a variable displacement pump operably connected to said engine, said pump including a rotating swashplate being adapted to operate at selective angles, said angle of the swashplate dictating a pump displacement, the pump displacement ranging from a zero displacement to a maximum displacement;
a hydraulic circuit adapted to receive a flow of fluid from said pump, said pump being adapted to circulate the flow of fluid at a flow rate through said hydraulic circuit, said hydraulic circuit capable of operating at or below a maximum hydraulic circuit flow rate;
said pump is capable of pumping the maximum hydraulic circuit flow rate of fluid into the hydraulic circuit while the engine operates at the rotational speed and while the swashplate is disposed at an operating angle corresponding to an operating displacement that is less than the maximum displacement.

2. The hydrostatically driven vehicle of claim 1, wherein the rotational speed is 1600 revolutions per minute.

3. The hydrostatically driven vehicle of claim 1, wherein the operating angle corresponds to an operating displacement that is less than 70% of the maximum displacement.

4. The hydrostatically driven vehicle of claim 1, wherein the pump is capable of providing a pump flow rate at the rotational speed when the pump swashplate is set to the maximum displacement, the pump flow rate at the rotational speed when the pump swashplate is set to the maximum displacement being greater than the maximum hydraulic circuit flow rate.

5. The hydrostatically driven vehicle of claim 1, further including a hydraulic motor adapted to receive at least a portion of the flow of fluid circulating in the hydraulic circuit.

6. The hydrostatically driven vehicle of claim 5, wherein the hydraulic motor is capable of operating at or below the maximum hydraulic circuit flow rate.

7. The hydrostatically driven vehicle of claim 6, wherein the hydraulic motor is operably connected to a wheel.

8. The hydrostatically driven vehicle of claim 6, wherein the hydraulic motor is operably connected to an implement.

9. A method for operating a hydraulic system, comprising:
operating to compress a flow of hydraulic fluid with a variable displacement pump;
circulating the flow of hydraulic fluid through a hydraulic circuit having a maximum flow capacity;
controlling a rate of flow of the hydraulic fluid by changing a displacement setting of the pump, the displacement setting of the pump controllable between a zero displacement setting and a maximum displacement setting;
wherein the pump is capable of pumping a fluid at the maximum flow capacity of the hydraulic circuit at an intermediate displacement setting that is higher than the zero displacement setting and lower than the maximum displacement setting.

10. The method of claim 9, wherein the intermediate displacement setting of the pump is about 70% of the maximum displacement setting.

11. The method of claim 9, further comprising operating a hydraulic motor with the flow of hydraulic fluid, the hydraulic motor operably associated with the hydraulic circuit.

12. The method of claim 11, further comprising propelling a vehicle by rotating a wheel connected to the hydraulic motor.

13. The method of claim 11, further comprising operating a vibrator arrangement connected to the hydraulic motor.

14. The method of claim 9, wherein the hydraulic system is integrated in a hydrostatically operated vehicle.

15. The method of claim 9, wherein operating to compress the flow if hydraulic fluid includes rotating an input shaft of the pump with an engine operating at an engine speed.

16. The method of claim 15, wherein the engine speed is 1600 revolutions per minute.

17. The method of claim 9, wherein the pump operating at the maximum displacement setting is capable of producing a maximum fluid flow that is greater than the maximum flow capacity of the hydraulic circuit.

18. The method of claim 19, wherein the maximum fluid flow is at least 30% greater than the maximum flow capacity.

19. A machine, comprising:
a hydraulic circuit including a plurality of fluid conduits, the plurality of fluid conduits having a maximum flow capacity;
a variable displacement fluid pump, the fluid pump operable to circulate a flow of hydraulic fluid through the plurality of fluid conduits, the fluid pump operating at a displacement setting, the displacement setting ranging between a zero displacement setting and a maximum displacement setting, wherein a flow rate of the flow of hydraulic fluid depends on the displacement setting, with a maximum flow rate occurring at the maximum displacement setting of the fluid pump;
an engine operably connected to the fluid pump, the engine operating at an engine speed and providing power to the fluid pump;
a hydraulic motor receiving the flow of hydraulic fluid during operation of the fluid pump, the hydraulic motor responsive to the flow rate of the flow of hydraulic fluid, the hydraulic motor capable of operating below the maximum flow capacity;
wherein the fluid pump is capable of circulating hydraulic fluid at or below the maximum flow capacity of the fluid conduits and the hydraulic motor when the fluid pump operates at an intermediate displacement setting, the intermediate displacement setting being below the maximum displacement setting.

20. The machine of claim 19, wherein the machine is a hydrostatically driven vehicle, wherein the engine operates at about 1600 revolutions per minute, and wherein the hydraulic motor is a bidirectional propel motor operating to rotate a wheel, the wheel propelling the hydrostatically driven vehicle along a base surface.
